(19) United States
(12) Patent Application Publication
(10) Pub. No.: US 2005/0262276 A1
(43) Pub. Date: Nov. 24, 2005

(54) Design method for implementing high memory algorithm on low internal memory processor using a direct memory access (DMA) engine

(75) Inventors: Kismat Singh, Bangalore (IN); Murali Babu Muthukrishnan, Bangalore (IN); Sriram Sethuraman, Bangalore (IN); Sankaranarayanan Parameswaran, Banglaore (IN); Bhavani Gopatakrishna Rao, Bangalore (IN)

Correspondence Address: Global IP Services, PLLC;c/o PortfolioIP, P.O. Box 52050, Minneapolis, MN, 55402, US

(73) Assignee: Ittiam Systamc (P) Ltd.

(21) Appl. No.: 11/126,556

(22) Filed: May 11, 2005

Related U.S. Application Data
(60) Provisional application No. 60/570,757, filed on May 13, 2004.

(51) Int. Cl. G06F 13/28

(52) U.S. Cl. 710/22

(57) ABSTRACT

A design method for implementing a high-memory algorithm for motion estimation and compensation uses a low internal memory processor and a DMA engine that interacts with the processor and the algorithm. The DMA takes care of large data transfers from an external memory to the processor internal memory and vice-versa, without using the CPU clock cycles. The design method is scalable and is suited to handle huge bandwidths without slowing down the processor. To prevent the processor from being idle during DMA, the processing is pipelined and staggered so that motion compensation is performed on an earlier block or data that is available, while DMA fetches the reference data for the current block. Several DMAs may be set up under an ISR if necessary. The invention has application in video decoders including those conforming to H.264, VC-1, and MPEG-4 ASP.

### RELATED APPLICATIONS

Benefit is claimed under 35 U.S.C. 119(e) to U.S. Provisional Application Ser. No. 60/570,757, entitled “An optimal design for implementing high memory algorithm with low internal memory processor with a DMA engine” by Kismat Singh et al., filed May 13, 2004, which is herein incorporated in its entirety by reference for all purposes.

### FIELD OF THE INVENTION

This invention generally relates to motion estimation and compensation, and more particularly to a design method for implementing an algorithm for a low internal memory processor using a DMA (direct memory access) engine.

### BACKGROUND OF THE INVENTION

Motion estimation is an indispensable tool in handling video information, wherein frames of information are encoded for processing. A motion estimation system computes a description of the video scene, and the motion information is used to predict a current frame from a previous frame. In that process, there is need for large volumes of information to be brought into the memory of a processor. Often a direct memory access (DMA) approach is used for the purpose. DMA allows certain hardware subsystems within a computer to access system memory for reading and/or writing independently of the main CPU. Examples of systems that use DMA include Hard Disk Controller, Disk Drive Controller, Graphics Card, and Soundcard. DMA is a significant feature of all modern computers, as it allows devices of different speeds to communicate without subjecting the CPU to a massive interrupt load. A DMA transfer essentially copies a block of memory from one device to another. While the CPU initiates the transfer, the transfer itself is performed by the DMA controller. A typical example is, moving a block of memory from external memory to faster, internal (on-chip) memory. Such an operation does not stall the processor and as a result it can be scheduled to perform other tasks. DMA transfers are very useful for high performance embedded algorithms and, a skillful application thereof could outperform the use of a cache. “Scatter-gather” DMA allows the transfer of data to multiple memory areas in a single DMA transaction. It is equivalent to the chaining together of multiple simple DMA requests. Again, the motivation is to off-load multiple I/O interrupt and data copy tasks from the CPU. It is desirable to address DMA transfers in the context of processors that have relatively low internal memory.

### SUMMARY OF THE INVENTION

One embodiment of the invention resides in a design method for implementing a processing step that requires to be preceded by an external memory access on information blocks, said design method using a low internal-memory processor and a DMA (direct memory access) engine, comprising the steps of: staggering a processing operation in said processor over a plurality of blocks of information; performing said processing operation on a given block of information during a given time interval; and, using said DMA engine to fetch reference data for a block which is later in processing order than said given block during said given time interval, reducing a waiting time faced by said processor.

A second embodiment of the invention resides in a design method for implementing motion compensation for processing information blocks, said design method using at least one low internal-memory processor and a DMA (direct memory access) engine, comprising the steps of: performing bit-stream parsing and entropy decoding on multiple macroblocks; and, after parsing is finished on the multiple macroblocks, starting motion compensation along with inverse transform and reconstruction for the same set of multiple macroblocks.

Another embodiment teaches a design method for implementing an external memory algorithm for motion estimation and compensation on information blocks using a low internal-memory processor and a DMA (direct memory access) engine, the design method comprising: moving an initial search area for a first macroblock in a row using 2D-DMA to a processor internal memory; and, for subsequent macroblocks in said row, fetching one additional column from external memory and over-writing a column that is no longer needed.

A further embodiment teaches a design method for implementing an external memory access algorithm for motion estimation and compensation on information blocks using a low internal-memory processor and a DMA (direct memory access) engine, wherein the DMA engine provides a predetermined number of descriptors and a desired number of descriptors is higher, the method comprising the steps of: configuring up to said predetermined number of descriptors; setting a last of a desired subset of configured descriptors to interrupt the processor after completion of all transfers in said desired subset; triggering a set of transfers; configuring additional descriptors that have not been configured when new transfer parameters are known; and performing said configuring, setting, and triggering steps in an interrupt service routine when the last transfer of said desired subset interrupts the processor, until said desired number of descriptor count is reached.

Another embodiment teaches design method for implementing a high-memory algorithm for motion estimation and compensation on information macroblocks using a low internal-memory processor and a DMA (direct memory access) engine, wherein a DMA which is set up requires to be repeated for each of said macroblocks, the method comprising: choosing a common set of parameters for a particular type of DMA transfer; keeping a decoded macroblock in a known constant location after every macroblock is decoded; and, ensuring that after completion of every DMA transfer, only a destination address is changed.

Yet another embodiment teaches design method for implementing a high-memory algorithm for motion estimation and compensation on information macroblocks using a low internal-memory processor and a DMA (direct memory access) engine, said method using a plurality of DMAs and a plurality of row accesses in SDRAM (synchronous dynamic random access memory), said method including the step of creating a bounding box to ease a number of DMAs and absorb several motion vectors in one transfer, the step of creating a bounding box using one or more of criteria:
1. The total memory needed to bring in the bounding box is the same as if the bounding boxes were not used.
2. The total number of row accesses is minimized.
3. The overall DMA bandwidth is minimized.

Also included herein are articles comprising a storage medium having instructions thereon which when executed by a computing platform result in execution of any of the methods recited above. The invention is particularly applicable as a design-method implemented in an algorithm for use in a video encoder conforming to one of H.264, VC-1, and MPEG-4 ASP. The invention is also applicable in any scenario where a high memory algorithm is used in conjunction with a relatively low internal memory processor and a DMA engine.

The following advantageous features may be noted from the different implementations of the invention:
1. Configurable design to handle any huge memory requirement.
2. Configurable design to handle any number of DMAs.
3. Configurable design to handle small internal memory of the processor.
4. Minimum penalty on the CPU.

### BRIEF DESCRIPTION OF THE DRAWING

A more detailed understanding of the invention may be had from the following description of preferred embodiments given by way of example only and not a limitation, to be understood in conjunction with the accompanying drawing wherein;

FIG. 1 is a block diagram general purpose computing platform which can be used in the implementation of the present invention.

### DETAILED DESCRIPTION OF PREFERRED EMBODIMENTS

In the following detailed description of the various embodiments of the invention, reference is made to the accompanying drawing that forms a part hereof, and in which are shown by way of illustration specific embodiments in which the invention may be practiced. The embodiments are described in sufficient detail to enable those skilled in the art to practice the invention, and it is to be understood that other embodiments may be utilized and that modifications may be made without departing from the scope of the present invention. The following detailed description is therefore not to be taken in a limiting sense, but only as exemplary.

Audio-Video systems usually involve large amount of data processing and data-movement. This large amount of data needs to be kept in the external memory (usually in SDRAM, which stands for synchronous dynamic random access memory) since most processors would have a restriction on the internal memory (fast access RAMs). This invention teaches a design method that addresses the huge amount of data transfers required without using the CPU clock cycles and transfers data from external memory to internal memory (and vice-versa) using the DMA channel. This ensures minimum internal memory usage and also lower processor utilization. The design is fine-tuned to handle complex two-dimensional DMA transfers and is adaptable to work for any configuration of the internal memory. The design is scalable and is also suited to handle huge bandwidth without slowing down the CPU. The design is non-intrusive in the sense that this does not require a change in the Encoder/Decoder design.

Implementation 1: This implementation addresses staggering the processing and DMA on group of units. The term “units” as used herein is to be understood to mean sub-blocks or blocks or macroblocks for processing.

In decoders, motion vectors are available after parsing the bit stream. Typically, the reference pictures are stored in external memory. To perform motion compensation immediately following the parsing of the motion vector (MV) or motion vector data (MVD), the reference area that the motion vector points to needs to be fetched. The organization of the reference frame is typically raster scan order of the frame. To fetch a 2-D block from this via cache will result in multiple cache line misses. To avoid such misses, the DMA can be used. To prevent the processor from being idle during DMA, the processing is staggered so that the motion compensation is performed on an earlier block for which the reference data is already fetched using DMA. During this time, DMA fetches the reference data for the current block.

This implementation generalizes the staggering to minimize the waiting time faced by the processor. For instance, several macroblocks could be skipped in a sequence in the bit stream. In this case, the parsing load is not sufficient to hide the fetching of the reference blocks. While some part of the DMA can be hidden against the sub-pixel interpolation of the reference area, sub-pixel refinement is optional at the encoder and sub-pixel accurate motion vector may not be present for every single block. In most of the advanced video decoders (such as H.264, VC-1, MPEG-4 ASP, etc.), many tools are used (e.g., advanced entropy decoding, motion vector prediction, DMA setup, sophisticated motion compensation, inverse quantization, inverse transform, and in-loop filtering) and the number of processing steps and variants of the processing steps (the coding modes) on a unit of data (e.g., macroblock) are so many that the code size for the various processing stages might amount to several Kbytes, several factors of the typical I-cache sizes in typical low-cost processors. Hence, it becomes impractical to perform DMA staggering in a tight loop with all of the processing stages. This further reduces the time available to fetch the reference data. To simultaneously ease the I-cache thrashing and to hide the DMA latency, this invention implements the following processing pipeline:
1. Perform the bit stream parsing and entropy decoding on multiple units (e.g. multiple macroblocks). The DMA for reference data is configured at a chosen granularity, the earliest of which is as soon as the MV data is available for a given block.
2. Once the parsing finishes on multiple blocks or macroblocks, start the motion compensation process along with inverse transform and reconstruction on the same set of processing macroblocks.
   The parsing step over multiple macroblocks or units provides a minimum time for DMA of the first reference block to take place before that data is needed for motion compensation in spite of statistical variations mentioned earlier. The motion compensation and inverse transform/reconstruction steps of earlier macroblocks provide additional time for the DMAs for the subsequent MBs to complete. The splitting of processing can be generalized to arbitrary number of loops on a certain number of blocks or macroblocks to perform a certain group of processing tasks.
   The above steps are applicable to an encoder as well when, for example, the chrominance data is needed for motion compensation after a luminance based motion estimation step (—herein luma motion estimation—) is performed. In this case, the luma motion estimation and refinement over multiple units is performed and the DMA for the chroma for each of these units is set up. Then the chroma motion compensation and the rest of the encoding loop (such as transform, quantization, inverse quantization, inverse transform and reconstruction) over those units are performed. In this case, the statistical variation of the motion estimation algorithm and the I-cache thrashing are the reasons for spreading the operation over multiple units.

Implementation 2: In reusing the search area for motion estimation over multiple coding units, the advantages include:
Only bringing in one new column of coding units every time.
Offsetting the start of the region every time by the coding unit offset.
Using the overlap in a 2-D sense, if possible to reduce memory bandwidth
   Motion estimation typically uses search ranges that increase with resolution and the extent of motion in the class of sequences being encoded. Hence to find the best motion vector for a macroblock, several macroblocks around the corresponding region in the reference frame need to be fetched. (For instance, for a +/−16 search range, 9 macroblocks are needed for every macroblock search). However, the search ranges of adjacent macroblock have considerable overlap. In fact, the search ranges for two horizontally adjacent macroblock differ only by one column of search macroblocks. To avoid fetching the entire search range from external reference frame buffer memory to internal memory for motion search for each macroblock, the proposed implementation moves the initial search area for the first macroblock in a row using 2D-DMA to internal memory. For subsequent macroblocks on that row, this implementation fetches only one additional column from external memory and overwrites the column that is no longer needed. By moving the starting pointer by one macroblock and overwriting the last column (by treating the search area as a raster-scanned buffer), the new search range for the next macroblock is available in internal memory in the desired layout. The proposed method can be extended to exploit the overlap in the search range across multiple rows as well. However, in this case, the motion estimation may have to be performed out of raster scan order (if multiple rows do not fit into the internal memory).

Implementation 3: This addresses setting up additional DMAs under an ISR if the number of transfers exceeds the number of simultaneous DMAs that can be queued up or if a synchronization point is needed after every few transfers.

Typically, DMA engines provide a limited number of descriptors that store the transfer parameters. When DMA is used to access reference data across multiple motion partitions that fall within a N-macroblock set, there can be quite a few motion vectors (for instance, H.264 allows 32 motion vectors for a macroblock) and hence reference regions. When the maximum number of descriptors or the maximum queue length is reached, the rest of the transfer set-up cannot be done as soon as the transfer parameters are known. However, the desire will be to trigger the DMA transfers for these pending DMAs when the initial set of DMAs complete. If the triggering is done in regular software flow, valuable DMA cycles could be lost. This invention sets up an interrupt for the last of the transfer parameters. In the interrupt service routine for that interrupt, the additional setups are done to configure the reclaimed set of descriptors.

Another case where the same setup will be helpful even when the maximum number of descriptors is not reached is when the completion of a batch of transfers (e.g. all reference transfer for a macroblock) is needed by the processor. In this case, the transfers on the next set of already configured descriptors can be triggered in the ISR.

The overhead processing for ISR can be minimized by customizing the interrupt handling to avoid pushing and popping in general of a lot of registers.

Implementation 4: This implementation addresses reducing the set up overhead by pre-configuring a common set of parameters for a class of transfers (and only changing src/dst pointers on-the-fly). The implementation is aimed at minimizing the overheads incurred in setting up the DMAs. In encoders as well as decoders the processing happens at a macroblock (16×16) level. Therefore all the processing blocks are repeated for each macroblock being decoded (or encoded). So any DMA that is being setup will also be repeated for all the macroblocks. This unnecessary overhead of setting up the DMA can be avoided by having a common set of parameters for a particular type of transfer, e.g., writing back the decoded data from internal memory to the external frame memory through DMA. In this particular case the amount of DMA, the stride value (being a 2D DMA) and the length of the DMA all remain same across the macroblocks. The only change which will be macroblock dependant will be the destination address. If the decoded macroblock is kept in the same internal memory location after every macroblock is decoded, then the source address also remains the same across DMAs. Therefore all the invariant values as described above are written into the DMA setup phase and after completion of every DMA only the destination address is changed. This helps in saving the number of cycles required for setting up every DMA.

Implementation 5: This implementation addresses defining an interface that allows the target data to be either accessed directly from external memory or from internal memory (filled by DMA). This facilitates distribution of down-stream processing tasks to co-processors or other processors in a multi-processor situation.

As mentioned earlier, access to reference frame buffer data for motion compensation, typically happens by first DMAing the data into internal memory. However, for some block sizes (e.g. 2×2 blocks for chroma in H.264), DMA setup overhead may not justify the cycle savings by avoiding cache misses. Such transfers also lock up valuable DMA descriptors. This invention proposes to decouple the processing stage from the DMA setup stage so that the processing stage can be fed addresses either from external memory or from internal memory or from both. Bigger transfers, for which the cache miss overhead is significant, will be transferred through DMA to internal memory and the rest can be accessed directly from external memory. Such decoupling also has the advantage that the motion compensation stage need not know anything about the parse and DMA setup stages and hence can be offloaded to another processing core or co-processor with minimal information (such as partition information, where the data is located, alignment, and sub-pixel motion components).

Implementation 6: This implementation deals with alignment issues.

Aligned transfers are a lot faster than unaligned transfers as the underlying transfers tend to happen on bytes instead of on a much wider bus width. Typically, reference transfers will have arbitrary alignment as there is no constraint on the motion vector in the reference frame. However, when transfers are scheduled, the access is made to an aligned location in both internal and external memory to speed up the transfer. The offset from the aligned location to the actual unaligned location is remembered and used for actual processing. In some cases, it may not be possible to transfer invalid data to the destination buffer just to ensure alignment. In such cases, the transfer is split into 3 transfers, a transfer of the first unaligned bytes, followed by a transfer of the aligned words/double-words, and then the transfer of the last few unaligned bytes.

Implementation 7: This implementation addresses DMA of code dynamically, and overlaying in internal memory.

On most of the DSP processors there is a relatively small internal memory region which is usually not sufficient for holding all the code (for the decoder or encoder) and data. Also, the available I (Instruction) and D (Data) cache sizes are generally very small and hence it is not possible to cache the entire code or data. For any given processing requirement there would be portions of the code which are mutually exclusive i.e. for a given set of processing blocks scheduled on the available processors, there would be other blocks which cannot be scheduled on the processors at the same time and hence will be scheduled after completing the assigned tasks. In such a case, as the processing pipeline moves from one state to another, i.e., as one set of processing blocks is completed and the processor is scheduled to execute the next set of processing blocks, the code to be executed can be dynamically brought in to the internal memory. In order to hide the DMA cycles a ping-pong kind of buffer arrangement is made on the internal memory wherein the current processing block's codes resides in one buffer (ping) and the other buffer is being filled with the code that would be executed in the next processing stage. The dynamic code-downloads and overlay help in optimizing the performance by effectively using the internal memory space.

Implementation 8: This implementation addresses ways to overcome limitations such as 2D-2D DMA are not possible when the widths of the source and destination buffers are not the same (mainly C64x family)

When a target processor's DMA engine does not support 2D transfer of data from a source buffer to a destination buffer unless both the buffers have the same stride, the proposed invention, uses 2 DMAs—one 2D to ID DMA, and then one ID to 2D DMA to achieve the same effect as 2D-2D DMA with different strides.

Implementation 9: This implementation addresses creation of a bounding box to ease the number of DMAs and the number of row accesses in SDRAM

Standards such as MPEG-4 and H.264 allow motion vectors on sub-blocks (below the macroblock level). The side effect of this is that, the reference area from which the data needs to be accessed for motion compensation across these sub-blocks has no regularity. If multiple 2D-accesses are performed for each motion vector, the number of row accesses in SDRAM (which is quite expensive compared to a series of column accesses) for the entire macroblock can be very high. (For instance, in H.264, every 4×4 sub-block can have a bi-directional motion vector that is quarter pixel accurate with the sub-pixel interpolation being done using a 6-tap filter. In effect, a 4×4 block may need a 9×9 region for sub-pixel refinement. Thus, a considerable 9×16=144 row accesses will be needed for just one luma macroblock.) Typically, due to the tree structured sub-division, multiple motion vectors within a macroblock tend to have motion vectors that are not very far away from each other. Hence, if a clustering scheme is implemented to merge the motion vectors according to a given criteria, multiple bounding boxes can be created that absorb several motion vectors in one transfer. (For instance, if the motion vectors differed only in the sub-pixel part, the total bounding box needs to be only 22×22 and only 22 row accesses are needed instead of 144). Some criteria that can be used in creating the bounding boxes include:
1. The total memory needed to bring in the bounding box is the same as if the bounding boxes were not used
2. The total number of row accesses is minimized
3. The overall DMA bandwidth is minimized

Implementation 10: This implementation addresses DMA for filtering operations (keeping prior rows, bringing in new rows, storing fully processed rows, and storing partially processed rows optionally).

While performing 2D-filtering tasks that are at the block or macroblock level (such as de-blocking filter, de-ringing filter), the horizontal processing of the bottom part of the previous macroblock gets done in a first pass and the vertical processing of the same part happens after the next macroblock in the same column gets processed. The proposed implementation describes the different ways in which DMA can be setup for such situations. The sequence of transaction will be: bring in the prior few rows that have been partially processed from external memory, bring in the new rows that are yet to be processed from external memory (or if they are available just after decoding, there is no need to bring them in), perform the processing, store the fully processed rows (from both the set of rows) to external memory. In a special case where complete row of MBs worth of storage is available in internal memory, the partially processed rows can be kept in internal memory till they are fully processed.

The foregoing are exemplary implementations of the present design method for using a high memory algorithm for low level internal memory processor using a DMA engine. Described hereinabove is a design method for implementing a high-memory algorithm for motion estimation and compensation uses a low internal memory processor and a DMA engine that interacts with the processor and the algorithm. The DMA takes care of large data transfers from an external memory to the processor internal memory and vice-versa, without using the CPU clock cycles. The design method is scalable and is suited to handle huge bandwidths without slowing down the processor. To prevent the processor from being idle during DMA, the processing is pipelined and staggered so that motion compensation is performed on an earlier block or data that is available, while DMA fetches the reference data for the current block. Several DMAs may be set up under an ISR if necessary. The invention has application in video decoders including those conforming to H.264, VC-1, and MPEG-4 ASP. Features selectively offered by the implementations include the capability to handle any huge memory requirement, configurability to handle several DMAs, configurable design to handle a relatively small internal memory for the processor, and the possibility that there is minimum penalty on the CPU.

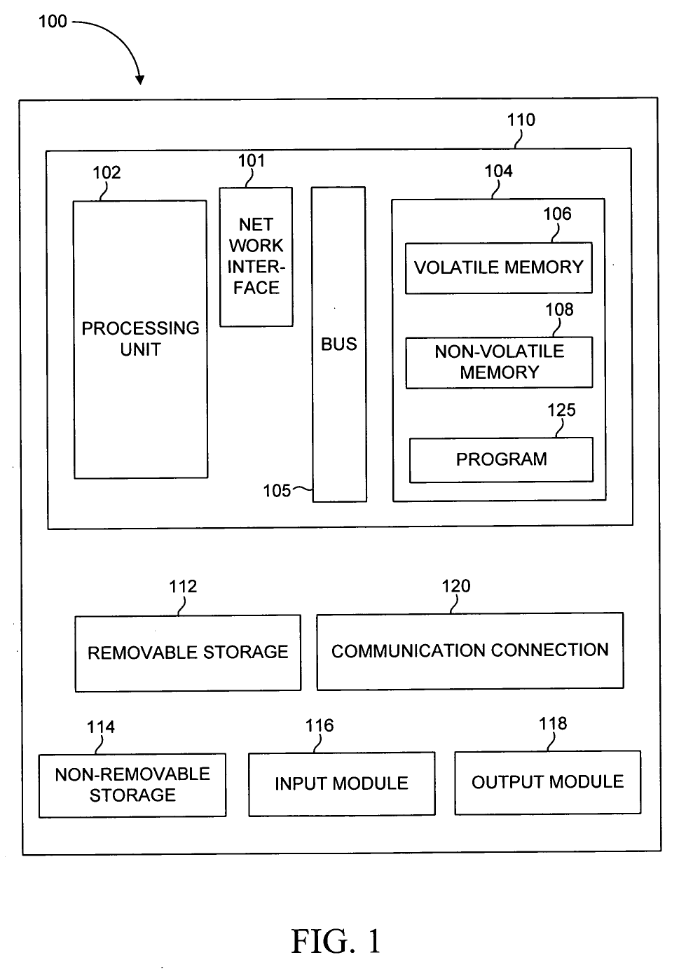

Various embodiments of the present subject matter can be implemented in software, which may be run in the environment shown in FIG. 1 or in any other suitable computing environment. The implementations of the present subject matter are operable in a number of general-purpose or special-purpose computing environments. Some computing environments include personal computers, general-purpose computers, server computers, hand-held devices (including, but not limited to, telephones and personal digital assistants (PDAs) of all types), laptop devices, multi-processors, microprocessors, set-top boxes, programmable consumer electronics, network computers, minicomputers, mainframe computers, distributed computing environments and the like to execute code stored on a computer-readable medium. It is also noted that the embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

FIG. 1 shows an example of a suitable computing system environment for implementing embodiments of the present subject matter. FIG. 1 and the following discussion are intended to provide a brief, general description of a suitable computing environment in which certain embodiments of the inventive concepts contained herein may be implemented.

A general purpose computing device in the form of a computer 110 may include a processor unit 102, memory 104, removable storage 112, and non-removable storage 114. Computer 110 additionally includes a bus 105 and a network interface (NI) 101. Computer 110 may include or have access to a computing environment that includes one or more user input devices 116, one or more output modules or devices 118, and one or more communication connections 120 such as a network interface card or a USB connection. The one or more user input devices 116 can be a touch screen and a stylus and the like. The one or more output devices 118 can be a display device of computer, computer monitor, TV screen, plasma display, LCD display, display on a touch screen, display on an electronic tablet, and the like. The computer 110 may operate in a networked environment using the communication connection 120 to connect to one or more remote computers. A remote computer may include a personal computer, server, router, network PC, a peer device or other network node, and/or the like. The communication connection may include a Local Area Network (LAN), a Wide Area Network (WAN), and/or other networks.

The memory 104 may include volatile memory 106 and non-volatile memory 608. A variety of computer-readable media may be stored in and accessed from the memory elements of computer 110, such as volatile memory 106 and non-volatile memory 108, removable storage 112 and non-removable storage 114. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like, chemical storage, biological storage, and other types of data storage.

“Processor” or “processor unit,” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processor unit 102 of the computer 110. For example, a computer program 125 may include machine-readable instructions capable of executing a design method using a high-memory algorithm for motion estimation and compensation according to the teachings of the described implementations/embodiments of the present subject matter. In one embodiment, the computer program 125 may be included on a CD-ROM and loaded from the CD-ROM to a hard drive in non-volatile memory 108. The machine-readable instructions cause the computer 110 to decode according to the various embodiments of the present subject matter.

The various implementations/embodiments of the design method using a high-memory algorithm and a DMA engine for motion estimation and compensation where a low internal memory processor is used, as described herein are in no way intended to limit the applicability of the invention. Many other embodiments will be apparent to those skilled in the art. The scope of this invention should therefore be determined by the appended claims as supported by the text, along with the full scope of equivalents to which such claims are entitled.

1. A design method for implementing a processing step that requires to be preceded by an external memory access on information blocks, said design method using a low internal-memory processor and a DMA (direct memory access) engine, comprising the steps of:
staggering a processing operation in said processor over a plurality of blocks of information;
performing said processing operation on a given block of information during a given time interval; and,
using said DMA engine to fetch reference data for a block which is later in processing order than said given block during said given time interval, reducing a waiting time faced by said processor.

2. A design method for implementing motion compensation for processing information blocks, said design method using at least one low internal-memory processor and a DMA (direct memory access) engine, comprising the steps of:
performing bit-stream parsing and entropy decoding on multiple macroblocks; and,
after parsing is finished on the multiple macroblocks, starting motion compensation along with inverse transform and reconstruction for the same set of multiple macroblocks.

3. The design method as in claim 2, wherein said step of motion compensation is performed using reference blocks for motion compensation that are fetched using a plurality of DMAs that are set up after said bit stream parsing and entropy coding step on a corresponding set of macroblocks.

4. The design method of claim 3, including the step of extending the processing to an encoder, wherein chrominance data is needed for motion compensation.

5. The design method of clam 1, including performing luma-motion estimation and refinement over multiple macroblocks, and including setting up DMA use for chroma of said multiple macroblocks.

6. The design method of clam 5, including the step of performing chroma motion compensation and remaining encoding operation including transform quantization, inverse quantization, inverse transform and reconstruction over said multiple macroblocks.

7. The design method as in claim 1, implemented in an algorithm for use in a video encoder.

8. A design method for implementing an external memory access algorithm for motion estimation and compensation on information blocks, said design method using a low internal-memory processor and a DMA (direct memory access) engine, the design method comprising:
moving an initial search area for a first macroblock in a row using 2D-DMA to a processor internal memory; and,
for subsequent macroblocks in said row, fetching one additional column from external memory and over-writing a column that is no longer needed.

9. The design method as in claim 8, implemented in an algorithm for use in a video encoder.

10. A design method for implementing an external memory access algorithm for motion estimation and compensation on information blocks using a low internal-memory processor and a DMA (direct memory access) engine, wherein the DMA engine provides a predetermined number of descriptors and a desired number of descriptors is higher, the method comprising the steps of:
configuring up to said predetermined number of descriptors;
setting a last of a desired subset of configured descriptors to interrupt the processor after completion of all transfers in said desired subset;
triggering a set of transfers;
configuring additional descriptors that have not been configured when new transfer parameters are known; and
performing said configuring, setting, and triggering steps in an interrupt service routine when the last transfer of said desired subset interrupts the processor, until said desired number of descriptor count is reached.

11. The design method as in claim 10, including the step of decoupling a processing stage from a DMA set up stage, and feeding the processing stage with addresses from either an external memory or an internal memory, or both.

12. A design method for implementing a high-memory algorithm for motion estimation and compensation on information macroblocks using a low internal-memory processor and a DMA (direct memory access) engine, wherein a DMA which is set up requires to be repeated for each of said macroblocks, the method comprising:
choosing a common set of parameters for a particular type of DMA transfer;
keeping a decoded macroblock in a known constant location after every macroblock is decoded; and,
ensuring that after completion of every DMA transfer, only a destination address is changed.

13. The design method as in claim 1, including DMA transfers that may be aligned or nonaligned with an offset, the method including the steps of:
attempting DMA transfer to aligned locations both in internal and external memory; and,
where alignment is not ensured, noting an offset between an aligned and a nonaligned location and splitting a DMA transfer into three groups comprising: first unaligned bytes; second, aligned words/double words; and third, remaining unaligned bytes.

14. The design method as in claim 1, including the step of dynamically bringing in code to be executed into said internal memory, the method including the steps of
providing a first buffer in the internal memory for holding code for a current processing stage; and,
providing a second buffer for handling code that would be executed in a next processing stage.

15. The design method as in claim 1, including source and destination buffers of dissimilar widths, said method including the step of using two DMAs in one of said buffers.

16. The design method as in claim 10, implemented in an algorithm for use in a video encoder.

17. The design method as in claim 12, implemented in an algorithm for use in a video encoder.

18. A design method for implementing a high-memory algorithm for motion estimation and compensation on information macroblocks, using a low internal-memory processor and a DMA (direct memory access) engine, said method using a plurality of DMAs and a plurality of row accesses in SDRAM (synchronous dynamic random access memory), said method including the step of creating a bounding box to ease a number of DMAs and absorb several motion vectors in one transfer, the step of creating a bounding box using one or more of criteria:
1. Total memory needed to bring in the bounding box is the same as if the bounding boxes were not used.
2. Total number of row accesses is minimized.
3. Overall DMA bandwidth is minimized.

19. The design method as in claim 18, implemented in an algorithm for use in a video encoder conforming to one of H.264, VC-1, and MPEG-4 ASP.

20. The design method as in claim 1, including the step of configuring the DMA engine for filtering operations including keeping prior rows, bringing in new rows, storing fully processed rows, and optionally storing partially processed rows.

21. An article comprising a storage medium having instructions thereon which when executed by a computing platform result in execution of a design method for implementing a processing step that requires to be preceded by an external memory access on information blocks, said design method using a low internal-memory processor and a DMA (direct memory access) engine, comprising the steps of:
staggering a processing operation in said processor over a plurality of blocks of information;
performing said processing operation on a given block of information during a given time interval; and,
using said DMA engine to fetch reference data for a block which is later in processing order than said given block during said given time interval, reducing a waiting time faced by said processor.

22. An article comprising a storage medium having instructions thereon which when executed by a computing platform result in execution of a design method for implementing motion compensation for processing information blocks, said design method using at least one low internal-memory processor and a DMA (direct memory access) engine, comprising the steps of:
performing bit-stream parsing and entropy decoding on multiple macroblocks; and,
after parsing is finished on the multiple macroblocks, starting motion compensation along with inverse transform and reconstruction for the same set of multiple macroblocks.

23. An article comprising a storage medium having instructions thereon which when executed by a computing platform result in execution of a design method for implementing an external memory access algorithm for motion estimation and compensation on information blocks, said design method using a low internal-memory processor and a DMA (direct memory access) engine, the design method comprising:
moving an initial search area for a first macroblock in a row using 2D-DMA to a processor internal memory; and,
for subsequent macroblocks in said row, fetching one additional column from external memory and over-writing a column that is no longer needed.

24. An article comprising a storage medium having instructions thereon which when executed by a computing platform result in execution of a design method for implementing an external memory access algorithm for motion estimation and compensation on information blocks using a low internal-memory processor and a DMA (direct memory access) engine, wherein the DMA engine provides a predetermined number of descriptors and a desired number of descriptors is higher, the method comprising the steps of:
configuring up to said predetermined number of descriptors;
setting a last of a desired subset of configured descriptors to interrupt the processor after completion of all transfers in said desired subset;
triggering a set of transfers;
configuring additional descriptors that have not been configured when new transfer parameters are known; and
performing said configuring, setting, and triggering steps in an interrupt service routine when the last transfer of said desired subset interrupts the processor, until said desired number of descriptor count is reached.

25. An article comprising a storage medium having instructions thereon which when executed by a computing platform result in execution of a design method for implementing a high-memory algorithm for motion estimation and compensation on information macroblocks using a low internal-memory processor and a DMA (direct memory access) engine, wherein a DMA which is set up requires to be repeated for each of said macroblocks, the method comprising:
choosing a common set of parameters for a particular type of DMA transfer;
keeping a decoded macroblock in a known constant location after every macroblock is decoded; and,
ensuring that after completion of every DMA transfer, only a destination address is changed.

26. An article comprising a storage medium having instructions thereon which when executed by a computing platform result in execution of a design method for implementing a high-memory algorithm for motion estimation and compensation on information macroblocks using a low internal-memory processor and a DMA (direct memory access) engine, said method using a plurality of DMAs and a plurality of row accesses in SDRAM (synchronous dynamic random access memory), said method including the step of creating a bounding box to ease a number of DMAs and absorb several motion vectors in one transfer, the step of creating a bounding box using one or more of criteria:
1. Total memory needed to bring in the bounding box is the same as if the bounding boxes were not used.
2. Total number of row accesses is minimized.
3. Overall DMA bandwidth is minimized.
